(19) United States
(12) Patent Application Publication
(10) Pub. No.: US 2009/0230035 A1
(43) Pub. Date: Sep. 17, 2009

(54) Advanced in-home water treatment system

(76) Inventor: Christopher Schulz, Centennial, CO (US)

Correspondence Address: Christopher R. Schulz;CDM Inc., 555 17th Street, Denver, CO, 80202, US

(21) Appl. No.: 12/077,022

(22) Filed: Mar. 17, 2008

(51) Int. Cl. C02F 1/32; B01J 19/12; B01D 24/38; C02F 1/00; C02F 1/48

(52) U.S. Cl. 210/108; 210/137

(57) ABSTRACT

A method and apparatus are provided for an advanced water treatment system that includes filtration, physical conditioning, and ultraviolet disinfection elements in a single unit. A control valve controls flow through the system in filtering, backwashing, cleaning, and rinsing modes of operation.

### FIELD OF THE INVENTION

The present invention relates to an integrated water treatment apparatus and method suitable for use as a point-of-entry system in the home. More particularly, the present invention relates to an improved home water treatment apparatus and method that integrates several water treatment stages in a single vessel for improved water quality, including particulate filtration for removing sediment and turbidity, physical water conditioning to prevent hard water scale formation and ultraviolet light disinfection for microorganism inactivation.

### BACKGROUND OF THE INVENTION

Point-of-entry water treatment arrangements for use in homes have been available for some time. These devices are arranged near the home water-service entry point to provide whole-house water treatment. The point-of-entry devices in common use range from simple particulate filter elements for filtering solid particles present in the incoming water, to more complex filter elements for removing specific dissolved chemicals present in the incoming water, such as chlorine, hardness (calcium and magnesium ions) and organic contaminants. Point-of-entry water treatment units may also incorporate ultraviolet lamps for disinfection by exposing incoming water to ultraviolet light in order to inactivate pathogens and other microorganisms that may be present in the water.

Typically, separate treatment units must be used for removal of particulate, chemical and microbial contaminants in water for household use. It is therefore desirable to provide in a unitary vessel a treatment system for removing particulates and chemicals, for conditioning hard water (to prevent scale formation), and for disinfection of microorganisms. Desirably, such a vessel is of a relatively compact size and is one that is adaptable for retrofitting into existing household plumbing systems.

The first device to incorporate an ultraviolet (UV) light disinfection device inside a filter pressure vessel was described in U.S. Pat. No. 5,584,411, specifically a tank head that permits a UV lamp and UV-resistant tube to be attached thereto with their respective opposite ends suspended in the center of the tank vessel. The inlet and outlet ports of the tank head allow flow to be directed downwardly through the filter vessel, around the bottom end of the tube and then upwardly within the tube where water is exposed to UV light for disinfection treatment. This system was subsequently commercially developed by Cuno Water Treatment Company as the Biolite Ultraviolet System, which is explicitly incorporated by reference. Another system combined the aforementioned tank head technology with a granular media pressure filtration process to provide both filtration and UV disinfection in a single vessel, as disclosed in U.S. Pat. No. 5,916,439. Another system combined granular media pressure filtration and UV disinfection with a filter control valve that controls flow through the pressure filter and provides automatic periodic cleaning of the filter bed, as disclosed in U.S. patent application Ser. No. 11/029,857. While these devices meet the objective of providing a compact in-home water treatment system with capability to provide both filtration and disinfection treatment of water in a unitary vessel, none of them have incorporated a physical water conditioning device, such as the magnetic device disclosed in U.S. Pat. No. 4,299,700. This type of device avoids the need for using ion exchange media for removing hardness from water, which must be regenerated within the pressure vessel every few days using salt. A physical conditioning system is desirable for hard water treatment to prevent calcium carbonate (or lime) scale formation in the household plumbing system, as well as on the UV lamp sleeve of the treatment apparatus which operates at a high surface temperature and so is susceptible to fouling by calcium carbonate scale.

It is therefore an object of the present invention to provide a compact point-of-entry water treatment system for the home, small business or commercial use that incorporates three water treatment processes in a single pressure-rated vessel, specifically granular media filtration for particle and turbidity removal, UV disinfection for microorganism inactivation, and a physical water conditioner when treating water supplies with moderate to high hardness levels. It is another object to provide a physical water conditioning unit positioned between the filter media and UV lamp assembly in a pressure-rated vessel to condition the filtered water to prevent lime scaling of the UV lamp sleeve as water flows through the UV disinfection tube. It is a further object to provide a physical water conditioning unit in a pressure-rated vessel to condition the filtered water to prevent lime scale and scum formation, water spotting and other aesthetic water quality problems in household plumbing systems associated with water supplies with moderate to high hardness.

### SUMMARY OF THE INVENTION

Briefly stated, the present invention relates to a water treatment system that includes granular media filtration, physical water conditioning and ultraviolet disinfection elements in a single pressure-rated vessel.

In accordance with the preferred embodiment of the present invention, a water treatment system is provided that includes a cylindrical pressure vessel defining an opening at the top end of the vessel. A flow transfer tube assembly, consisting of an upper flow transfer tube, UV reactor tube and physical water conditioning unit, is centrally positioned within the pressure vessel and extends vertically from the bottom of the pressure vessel through the top opening in the pressure vessel. A UV lamp assembly is concentrically disposed within the UV reactor tube to disinfect water as it flows upwardly through the tube. A bed of granular filter media is disposed within the pressure vessel and substantially surrounds at least a portion of the flow transfer tube assembly. A coupling is adapted to receive and retain the upper flow transfer tube and UV lamp assembly, while sealably engaging the top opening in the pressure vessel. A flow control valve is mounted on the coupling and is adapted to control water flow through the flow transfer tube assembly and pressure vessel.

### BRIEF DESCRIPTION OF THE DRAWINGS

FIG. 1 is a cross-sectional side view of a water treatment system showing a flat-plate type filter media retainer and single-stage physical water conditioning unit according to a preferred embodiment of the present invention.

FIG. 2 is a cross-sectional side view of the bottom portion of a treatment system showing a nozzle-type filter media retainer and single-stage physical water conditioning unit according to the embodiment illustrated in FIG. 1.

FIG. 3 is a cross-sectional side view of a single-stage physical water conditioning unit for a water treatment system according to the embodiment illustrated in FIG. 1.

FIG. 4 is a cross-sectional side view of a two-stage physical water conditioning unit for a water treatment system according to the embodiment illustrated in FIG. 1.

### DESCRIPTION OF THE PREFERRED EMBODIMENT

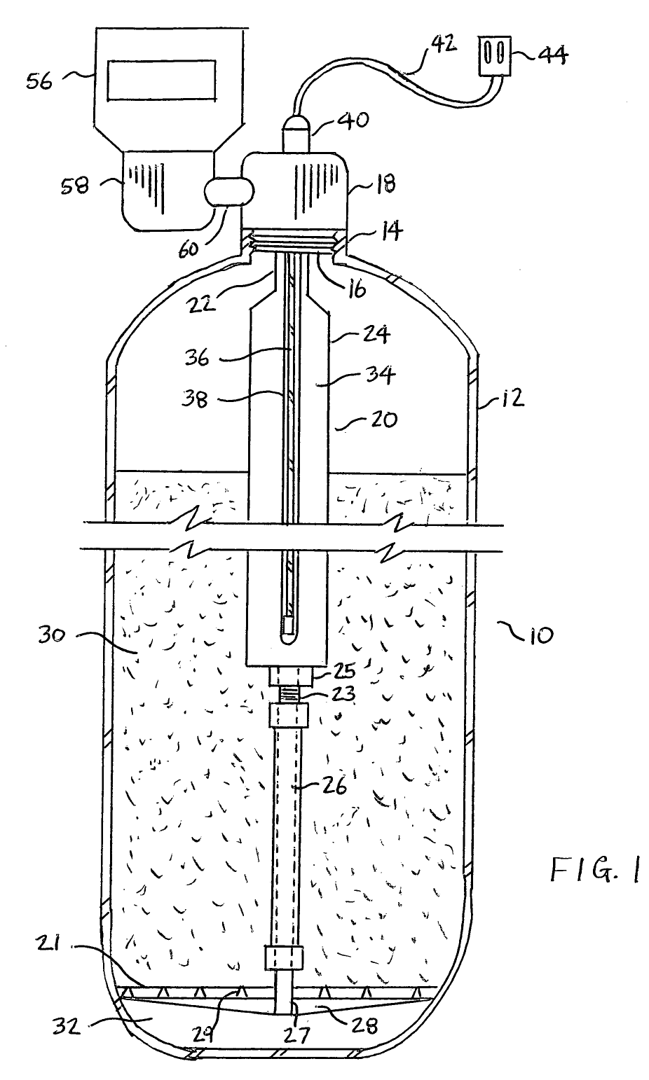

FIG. 1 is a cross-sectional side view with elements shown in phantom of a treatment system according to the preferred embodiment of the present invention. In this example the treatment system 10 includes a vertical cylindrical pressure vessel 12 such as those commonly used in point-of-entry home water treatment systems. Pressure vessel 12 may be constructed of any suitable material such as polyglass, fiberglass, or other materials commonly used to construct such vessels. Pressure vessel 12 defines a top opening 14 at one end of vessel 12.

Also as shown here, the top opening 14 in vessel 12 may be threaded to accept a threaded end 16 of a coupling 18 through which water may be supplied to and drawn from vessel 12. Generally, coupling 18 directs water flow into and out of the vessel 12.

The water treatment system 10 includes a flow transfer tube assembly 20, which extends from the bottom of vessel 12 through top opening 14 along the vessel's longitudinal centerline axis, and consists of upper flow transfer tube 22, UV reactor tube 24, physical water conditioning device 26 and pipe nipples 23,27. Upper flow transfer tube 22 is sealably connected with coupling 18 and, through coupling 18, provides a path for water flow into or out of vessel 12.

UV reactor tube 24, which may include a threaded, socket or welded top end connection which sealably engages the bottom end of flow transfer tube 22, extends further into pressure vessel 12 along the vessel's longitudinal centerline axis. The outside diameter of UV reactor tube 24 is preferably slightly smaller than top opening 14 so that it can be lowered into pressure vessel 12 during installation, while providing as large a diameter as possible to reduce the velocity of water flow though the reactor tube, thereby maximizing UV disinfection exposure time of the water. The length of UV reactor tube 24 is determined based on the minimum exposure time required for adequate disinfection and is typically 24 to 36 inches in length.

Physical conditioning unit 26, which may include a threaded or socket top end which sealably engages half-coupling 25 at the bottom end of UV reactor tube 24, such as through pipe nipple 23, extends further into pressure vessel 12 along the vessel's longitudinal centerline axis. The length and diameter of physical conditioning unit 26 is determined based on process design requirements such as the minimum exposure time and maximum water velocity required for effective physical water conditioning and is typically 9 to 18 inches in length.

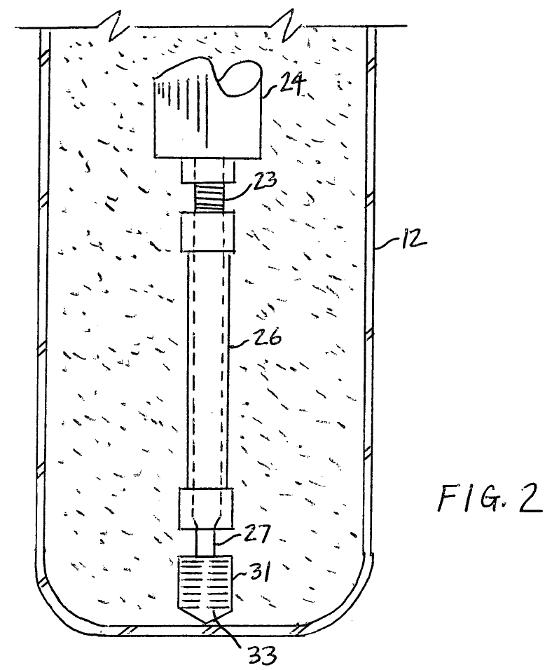

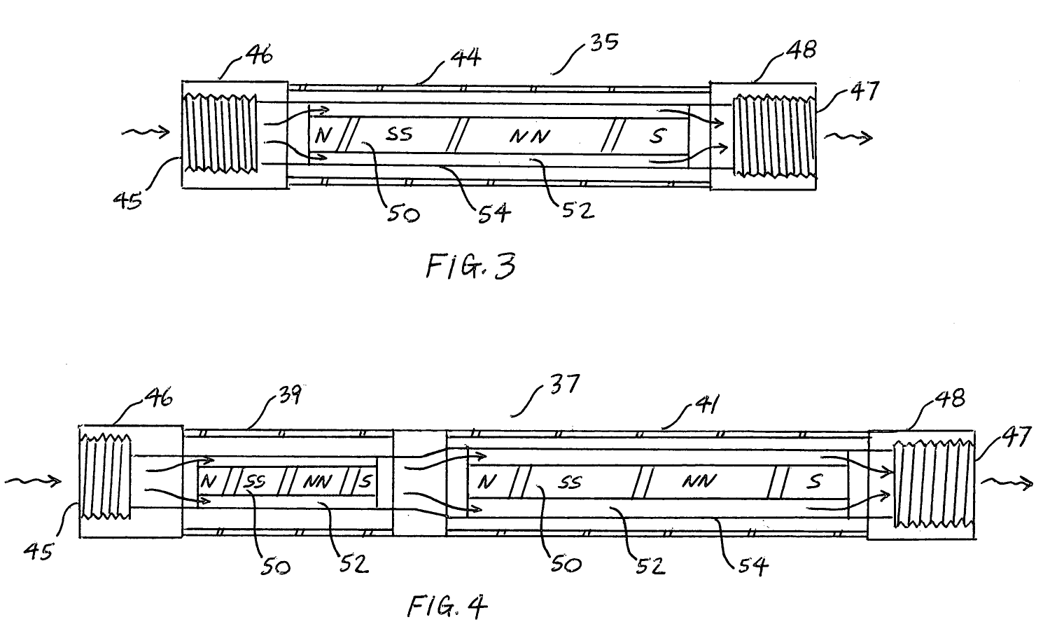

Water treatment system 10 further includes a filter media retainer 28. Filter media retainer 28 may include a threaded or socket end at its center, which sealably engages the bottom end of physical conditioning device 26, such as through pipe nipple 27. Furthermore, filter media retainer 28 is adapted to prevent granular filter media 30 from entering tank plenum 32 and transfer tube assembly 20, and may comprise a flat-plate type device 21 with narrow slotted apertures 29, as shown in FIG. 1, or a nozzle-type device 31 with narrow slotted apertures 33, as shown in FIG. 2, or similar type of system.

A bed of granular filter media 30 is located within pressure vessel 12 and substantially surrounds at least a portion of transfer tube assembly 20. The top of filter bed 30 is spaced below the top of pressure vessel 12 to provide adequate clearance for expanding the bed during a backwash cycle, as will be discussed later. Filter media bed 30 may comprise a single layer of filter media (as shown in FIG. 1) or multiple filter media layers and is provided to remove suspended or dissolved contaminants from the water. The exact type and configuration of filter media bed 30 for a particular application is based on specific water quality and treatment requirements.

An ultraviolet lamp assembly 34 is disposed within upper flow transfer tube 22 and UV reactor tube 24, coincident with the centerline longitudinal axes of tubes 22, 24. The bottom end of ultraviolet lamp assembly 34 preferably extends to just above the bottom end of UV reactor tube 24 to maximize the UV irradiance field within the tube for disinfection. Ultraviolet lamp assembly 34 provides a final disinfection treatment stage following filtration and physical water conditioning within pressure vessel 12. Furthermore, ultraviolet lamp assembly 34, as will be discussed further below, comprises a low-pressure germicidal lamp 36 housed inside a closed-end quartz sleeve 38. The top end of ultraviolet lamp assembly 34 is secured within coupling 18. A lamp end connector 40 located on top of coupling 18 is threadably received into coupling 18 with O-ring seals (not shown) to provide a watertight seal. A power cord 42 passes through an opening in end connector 40 and its opposite end is connected to lamp power supply plug 44. Lamp power supply plug 44 may contain a lighting ballast for igniting the lamp.

Physical conditioning unit 26, located within pressure vessel 12, has its top end sealably connected with half-coupling 25 and its bottom end sealably connected with filter media retainer 28. As is further illustrated in FIG. 4, physical conditioning unit 26 may consist of a single-stage unit 35 consisting of a closed cylindrical conduit 44 with an inlet end 46 and an outlet end 48. Inlet end 46 may include threaded connection 45, as shown in FIG. 4, to sealably engage physical conditioning unit 26 with filter media retainer 28. Likewise, outlet end 48 may include threaded connection 47 to sealably engage physical conditioning unit 26 with half-coupling 25 of UV reactor tube 24. A series of magnet elements 50 are positioned within closed conduit 44 along its centerline axis. Magnet elements 50 preferably consist of a series of multi-reversing magnets with north and south magnetic poles adjoining each other to produce a strong reversing magnetic field within the annular space 52 formed between magnets 50 and inner wall 54. This type of magnetic field is best suited to effect changes in the crystallization behavior of minerals present in the water to prevent formation of adherent scale on UV lamp assembly 34 and in the household plumbing system served by water treatment system 10.

As is further illustrated in FIG. 4, physical conditioning unit 26 may consist of a two-stage unit 37 including a smaller first-stage physical conditioning unit 39 and a larger second-stage physical conditioning unit 41. Both units are operated in series with water either flowing through the first smaller unit and then the second larger unit, or flowing through the first larger unit followed by the second smaller unit. Both units have the same components as described previously for single-stage unit 35, but the physical dimensions of the two stages of the unit are different. The two-stage physical conditioning arrangement is preferred when treating water supplies with highly variable flow rates, since the effectiveness of the magnetic conditioning unit is strongly related to flow velocity passing through the magnetic field. At low flows, the smaller unit 39 is effective in treating water at an optimum flow velocity, whereas at higher flows, the larger unit 41 is effective in treating water at an optimum flow velocity.

Water treatment system 10 may further comprise a control valve assembly 56, as shown in FIG. 1, that communicates with coupling 18 via a valve receptacle 58 and interconnection pipe 60. Control valve assembly 56 may be any of a variety of manually or automatically operated commercially available units and can include inlet, outlet, drain, and possibly chemical feed connections for operation of water treatment system 10. In addition, an automatically operated control valve assembly 56 may include a microprocessor and timer to control the frequency and duration of filter, backwash, and possibly, chemical cleaning and rinse cycles. For example, some automatically operated units that may be suitable include the Autotrol unit by GE Osmonics, Fleck 5600 by Pentair Water Corporation, and the WS1 by Clack Corporation.

In operation, pressurized, untreated water is supplied to treatment system 10 from the home's plumbing system to control valve assembly 56. In the typical filtering mode, control valve assembly 56 directs untreated water through internal inlet passageways (not shown) in control valve receptacle 58, interconnecting pipe 60 and coupling 18. Untreated water then flows from coupling 18, around the outside of upper flow transfer tube 22 and into pressure vessel 12. Once in pressure vessel 12, the untreated water flows through filter media bed 30, through filter media retainer 28, through tank plenum 32, and into the bottom end of flow transfer tube assembly 20. The water then flows up through physical conditioning unit 26, through UV reactor tube 24, around ultraviolet lamp assembly 34 and into the upper flow transfer tube 22. Water exits upper flow transfer tube 22 and flows through internal outlet passageways (not shown) in coupling 18, interconnection pipe 60 and valve receptacle 58, and into control valve assembly 56 to the supply line of the home's plumbing.

Since the filter media may require periodic cleaning to prevent clogging of filter media bed 30, a backwash cycle is provided to reverse flow through the system and clean the filter media. In a backwash cycle, control valve assembly 56 switches to direct, untreated water from the household's supply line through internal inlet backwash passageways (not shown) in valve receptacle 58, connector pipe 60 and coupling 18. From coupling 18, water flows into upper flow transfer tube 22, through UV reactor tube 24, around ultraviolet lamp assembly 34, through physical conditioning unit 26, and into tank plenum 32 at the bottom of tank 12. The water then flows from tank plenum 32, through slotted apertures 29 of filter media retainer 28, into and up through filter media bed 30, and out of pressure vessel 12 into coupling 18. From coupling 18, water flows through internal outlet backwash passageways (not shown) in coupling 18, interconnection pipe 60, valve receptacle 58 and out of control valve assembly 56 to a drain line of the home's plumbing.

The preferred embodiments and variations thereof illustrated in the accompanying figures and/or described above are merely exemplary and are not meant to limit the scope of the invention. It is to be appreciated that numerous variations of the invention have been contemplated as would be obvious to one of ordinary skill in the art with the benefit of this disclosure. All variations of the cover that read upon the appended claims are intended and contemplated to be within the scope of the invention.

What is claimed is:

1. A water treatment system for residential or commercial point-of-entry potable water treatment applications comprising:
a cylindrical pressure vessel defining an opening at the top end of the vessel;
a flow transfer tube assembly centrally positioned and vertically disposed within the pressure vessel, with its top end extending through the opening of the pressure vessel and its bottom end extending to the bottom of the pressure vessel;
a bed of granular filter media within the pressure vessel and substantially surrounding at least a portion of the flow transfer tube assembly;
a filter media retainer disposed at the bottom of the pressure vessel and sealably engaging the bottom end of the flow transfer tube assembly and adapted to prevent said granular filter media from entering the flow transfer tube assembly, while allowing water to flow freely in either direction through openings in the retainer;
an upper tube centrally positioned and vertically disposed within the pressure vessel and forming an integral component of the flow transfer tube assembly, its top end extending through the opening of the pressure vessel;
an ultraviolet reactor tube centrally positioned and vertically disposed within the pressure vessel and forming an integral component of the flow transfer tube assembly with its top end sealably engaging the bottom end of the upper tube;
a physical water conditioning unit centrally positioned and vertically disposed within the pressure vessel and forming an integral component of the flow transfer tube assembly with its top end sealably engaging the bottom end of the ultraviolet reactor tube;
an ultraviolet lamp assembly concentrically disposed within the upper tube and ultraviolet reactor tube;
a tank top coupling adapted to receive and retain the upper tube and ultraviolet lamp assembly, sealably engaging the top end of the upper tube and top end of the ultraviolet lamp assembly;
a flow control valve sealably connected to the tank top coupling and adapted to control water flow in two directions through the flow transfer tube assembly and pressure vessel.

2. The water treatment system of claim 1, wherein the physical water conditioning unit comprises a single enclosed cylindrical vessel with an inlet end and an outlet end, said vessel containing in-line magnets that create a magnetic flux within the vessel, said magnetic flux effectively treating water as it flows through the vessel to prevent scale formation on the ultraviolet lamp assembly and in the residential or commercial plumbing system served by the water treatment system.

3. The physical water conditioning unit of claim 2 wherein the in-line magnets have multiple reversing polarities that create a stronger magnetic flux than can be achieved with a standard 2-pole magnet.

4. The water treatment system of claim 1, wherein the physical water conditioning unit comprises two enclosed cylindrical vessels of different sizes and connected in series, each vessel containing in-line magnets that create a magnetic flux within the vessel, said magnetic flux effectively treating water as it flows through the vessels to prevent scale formation on the ultraviolet lamp assembly and in the residential or commercial plumbing system served by the water treatment system.

5. The physical water conditioning system of claim 4 wherein the in-line magnets for each enclosed cylindrical vessel have multiple reversing polarities to create a stronger magnetic flux than can be achieved with a standard 2-pole magnet.

6. The physical water conditioning system of claim 4 wherein the two enclosed cylindrical vessels consist of a smaller vessel followed by a larger vessel for treating water supplies with variable flows so that the smaller vessel provides effective treatment at lower flow rates and the larger vessel provides effective treatment at higher flow rates.

7. The physical water conditioning system of claim 4 wherein the two enclosed cylindrical vessels consist of a larger vessel followed by a smaller vessel for treating water supplies with variable flows so that the smaller vessel provides effective treatment at lower flow rates and the larger vessel provides effective treatment at higher flow rates.

8. The water treatment system of claim 1 wherein the ultraviolet lamp assembly comprises a low-pressure ultraviolet germicidal lamp housed inside a closed-end quartz glass sleeve.

9. The water treatment system of claim 1 wherein the ultraviolet lamp assembly comprises a low-pressure high-output ultraviolet germicidal lamp housed inside a closed-end quartz glass sleeve.

10. The water treatment system of claim 1 wherein the ultraviolet lamp assembly comprises a medium-pressure ultraviolet germicidal lamp housed inside a closed-end quartz glass sleeve.

11. The water treatment system of claim 1, wherein the media retainer device comprises a closed-end nozzle with narrow slotted openings adapted to prevent filter media from entering the flow transfer tube assembly, while allowing water to flow freely in either direction through openings in the media retainer device.

12. The water treatment system of claim 1, wherein the media retainer device comprises a horizontally disposed flat plate with narrow slotted openings adapted to prevent filter media from entering the flow transfer tube assembly, while allowing water to flow freely in either direction through openings in the media retainer device, said flat plate located at the bottom of the pressure vessel and sealably engaged thereto, providing improved flow distribution for filtering and filter cleaning operations.
